(19) United States
(12) Patent Application Publication
(10) Pub. No.: US 2025/0183951 A1
(43) Pub. Date: Jun. 5, 2025

(54) METHOD AND APPARATUS FOR DECOMPOSING MULTIPATH SIGNALS

(71) Applicant: Electronics and Telecommunications Research Institute, Daejeon (KR)

(72) Inventor: Kyungwon KIM, Daejeon (KR)

(73) Assignee: Electronics and Telecommunications Research Institute, Daejeon (KR)

(21) Appl. No.: 18/964,804

(22) Filed: Dec. 2, 2024

(30) Foreign Application Priority Data
Dec. 1, 2023 (KR) 10-2023-0172837
Nov. 27, 2024 (KR) 10-2024-0172837

(51) Int. Cl. H04B 7/0456

(52) U.S. Cl. CPC H04B 7/0456

(57) ABSTRACT

The present disclosure provides a multipath signal decomposition method enabling to estimate paths and path parameters. The method includes: (a) acquiring observation data including a plurality of multipath signal components; (b) for each multipath signal component, determining one or more basis vectors maximizing a projection; (c) calculating a residual using basis vectors having an orthogonality higher than a predetermined reference level with a new basis vector and performing a sub-optimization by updating a basis vector maximizing a projection of the residual among the basis vectors having the orthogonality lower than the reference level; (d) unless a termination condition is satisfied, repeating the operations (b) and (c) to determine an additional basis vector and determine basis vectors of a minimum number expressing a corresponding multipath signal component while avoiding a redundancy of the basis vectors; and (e) when the termination condition is satisfied, determining coefficients of basis vectors and parameters.

### CROSS-REFERENCE TO RELATED APPLICATION

The present application claims a convention priority under 35 U.S.C. § 119(a) based on Korean Patent Applications No. 10-2023-0172837 filed on Dec. 1, 2023, and No. 10-2024-0172837 filed on Nov. 27, 2024, the entire contents of which are incorporated herein in their entireties by reference.

### BACKGROUND

### 1. Technical Field

Exemplary embodiments relate to a method and apparatus for estimating a wireless channel and, more particularly, to a method and apparatus for decomposing each multipath signal component in a channel environment in which a plurality of multipath signal components exist and estimating parameters associated with each path.

### 2. Related Art

In wireless communication systems, radio waves propagate in various paths and arrive at a receiver with different time delays, angles of departure, angles of arrival, and in different powers during a process of being transmitted through space. Communication channels in such an environment are referred to as multipath channels. The multipath channels causes the transmitted signals to overlap each other and be distorted, and signal reliability may deteriorate. Modeling of such multipath channels and decomposition of multipath signal components are necessary for development and evaluation of a wireless transmission technology. In addition, the decomposition of multipath signal components may improve signal quality through a channel estimation and a correction of signal distortion in technical fields of equalization, frequency offset estimation, synchronization, and so on. Furthermore, the decomposition of multipath signal components may be used as a base technology in various technical fields such as MIMO spatial multiplexing for increasing a transmission speed and beamforming for reducing interferences and expanding a communication coverage.

In addition to communications, estimation information on a delay and an angle of arrival acquired through the multipath parameter estimation may be applied to various fields such as a radar system and an environmental monitoring. In particular, in a sixth generation (6G) communications system, an integrated sensing and communications (ISAC) technology combining sensing and communications and an orthogonal time frequency space (OTFS) technology for improving a signal transmission performance in time-varying channels are attracting attention. In addition, the decomposition of multipath signals may be applicable as an interference reduction technology if a discrimination of the multipath channels between two links is applied in an interference channel in which a reference signal of a receive signal is mixed with a reference signal of an interference signal. Both a discrimination of multipath channels and a discrimination of multiple signals ultimately distinguishes overlapping signals and may share base technologies.

The estimation of multipath channel parameters is the process of formulating a channel response into a sparse representation using parameters such as a delay time, an angle of arrival, and received intensity. The sparse representation has been widely used in the field of compressed sensing. In a theory of the compressed sensing, restricted isometric property (RIP) refers to a property that the higher an orthogonality of basis vectors of a signal is in a sparse representation, the smaller an error radius is. An environment in which the estimation of signal parameters is difficult is an environment in which the multipath channels are clustered. A clustered delay line (CDL) channel environment is an environment in which multiple paths are aggregated to form a single cluster. In the CDL channel environment, the orthogonality between the multiple paths is greatly reduced, so that the sensitivity to noise increases, which increases the error radius.

Matching pursuit (MP) is a greedy algorithm popular in the field of the compressed sensing. According to the MP algorithm, basis vectors are identified one by one and removed from a measured signal repeatedly to find a plurality of basis vectors. Various modified algorithms are derived in the process of optimizing sizes of the basis vectors. The MP algorithm is advantageous for a real-time implementation but exhibits a lowered performance in decomposing clustered multipath components. Meanwhile, space-alternating generating expectation maximization (SAGE) is a popular algorithm in the field of wireless channel research. The SAGE algorithm estimates multiple parameters through a probabilistic optimization and exhibits a much higher accuracy than the MP algorithm. However, the SAGE algorithm has a disadvantage of a very large computation amounts.

### SUMMARY

Exemplary embodiments provide a multipath signal decomposition method enabling to estimate paths and path parameters with a minimized number of basis vectors in a multipath cluster in a cluster delay line (CDL) channel environment where a plurality of paths are clustered to form a single channel so as to express a received signal in a sparsest representation while reducing signal parameter estimation errors.

Exemplary embodiments provide a multipath signal decomposition apparatus suitable for implementing the multipath signal decomposition method.

According to an aspect of an exemplary embodiment, a multipath signal decomposition method includes: (a) acquiring observation data including a plurality of multipath signal components from a signal received by a communication receiver; (b) for each multipath signal component, determining one or more basis vectors maximizing a projection to add to a basis vector dictionary; (c) calculating a residual using basis vectors having an orthogonality higher than a predetermined reference level with a new basis vector newly added to the basis vector dictionary and performing a sub-optimization of the basis vector dictionary by updating a basis vector maximizing a projection of the residual among the basis vectors having the orthogonality lower than the reference level; (d) when a predetermined termination condition is not satisfied, repeatedly performing the operations (b) and (c) to determine an additional basis vector and determine basis vectors of a minimum number which may express a corresponding multipath signal component while avoiding a redundancy of the basis vectors; and (e) when the termination condition is satisfied, determining coefficients of basis vectors of the minimum number and path parameters for the corresponding multipath signal component.

In the operation (a), the observation data may be acquired from a reference signal received by the communication receiver.

In the operation (b), the projection may be a projection of the observation data in a first iteration and is a projection of the residual in a second and subsequent iterations.

The operation (c) may include: determining a first subset to which the basis vectors having a distance greater than a predetermined threshold belong among basis vectors included in the basis vector dictionary and a second subset to which the basis vectors having the distance smaller than the threshold belong; calculating a residual using the observation data and the basis vectors belonging to the first subset; and determining a basis vector onto which the projection of the residual is maximized among the basis vectors belonging to the second subset.

The multipath signal decomposition method may further include: updating all basis vectors when the new basis vector is correlated with existing basis vectors.

The termination condition may be that an objective function falls below a predetermined tolerance level.

The termination condition may be that a number of the basis vectors reaches a predetermined maximum value.

The termination condition may be that an amount of computations reaches a predetermined upper limit for a total amount of computations.

According to another aspect of an exemplary embodiment, a multipath signal decomposition apparatus includes a processor and a memory storing program instructions to be executed by the processor. The program instructions when executed by the processor causes the processor to: (a) acquire observation data including a plurality of multipath signal components from a signal received by a communication receiver; (b) for each multipath signal component, determine one or more basis vectors onto which a projection is maximized to add to a basis vector dictionary; (c) calculate a residual using basis vectors having an orthogonality higher than a predetermined reference level with a new basis vector newly added to the basis vector dictionary and perform a sub-optimization of the basis vector dictionary by updating a basis vector maximizing a projection of the residual among the basis vectors having the orthogonality lower than the reference level; (d) when a predetermined termination condition is not satisfied, repeatedly perform the operations (b) and (c) to determine an additional basis vector and determine basis vectors of a minimum number which may express a corresponding multipath signal component while avoiding a redundancy of the basis vectors; and (e) when the termination condition is satisfied, determine coefficients of basis vectors of the minimum number and path parameters for the corresponding multipath signal component.

During the operation (a), the observation data may be acquired from a reference signal received by the communication receiver.

During the operation (b), the projection may be a projection of the observation data in a first iteration and is a projection of the residual in a second and subsequent iterations.

The program instructions causing the processor to perform the operation (c) may include instructions causing the processor to: calculate the residual using the basis vectors having the distance from the new basis vector greater than the threshold and update the basis vectors having the distance smaller than the threshold such that the projection of the residual is maximized; determine a first subset to which the basis vectors having the distance greater than the threshold among basis vectors included in the basis vector dictionary belong and a second subset to which the basis vectors having the distance smaller than the threshold belong; calculate a residual between the observation data and a combination of the basis vectors belonging to the first subset; and determine a basis vector onto which the projection of the residual is maximized among the basis vectors belonging to the second subset.

The program instructions may cause the processor to update all basis vectors when the new basis vector is correlated with existing basis vectors.

According to an exemplary embodiment, it is possible to decompose a superposed signal based on the projection maximization. The method according to an exemplary embodiment uses a probabilistic optimization similar to the SAGE algorithm, but provides a more accurate channel parameter estimation result with less computational amount than the SAGE algorithm by improving the optimization scheme. That is, the method according to the exemplary embodiment exhibits faster and higher parameter estimation performance than the SAGE algorithm.

The slow convergence of the SAGE algorithm is caused by an inaccuracy in the estimation of the basis vectors. When the SAGE algorithm searches for a new basis vector, it considers all previously found basis vectors as true and searches for another basis vector candidate closest to a residual which is a remainder after subtracting a reconstructed signal from a measured signal. Accordingly, any inaccuracy of a previously found basis vector estimation adversely affects a subsequent basis vector search. The estimation error accumulates as a number of basis vectors increases, continuously causing an incorrect estimation. Exemplary embodiments of the present disclosure may reduce the accumulation of errors and secures a fast convergence of the algorithm.

The method according to the present disclosure is applicable to various fields such as an evaluation of a channel environment, an evaluation of a communication quality of a communication system as well as an equalization, a frequency offset estimation, a synchronization, a MIMO multiplexing, a beamforming, a sensing, an object detection, and interference mitigation.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram of a communication system according to an exemplary embodiment of the present disclosure;

FIG. 2 is a block diagram showing a physical configuration of the multipath signal decomposition apparatus according to an exemplary embodiment of the present disclosure;

FIG. 3 is a flowchart showing a multipath signal decomposition method according to an exemplary embodiment of the present disclosure;

FIG. 4 shows a pseudocode of a projection maximization (ProMax) algorithm according to an exemplary embodiment of the present disclosure;

FIG. 5 shows a parameter estimation process performed by the multipath signal decomposition method according to an exemplary embodiment in comparison with a process performed by a conventional SAGE algorithm;

FIG. 6A, FIG. 6B, FIG. 6C, and FIG. 6D show simulation results of the method according to an exemplary embodiment of the present disclosure in comparison with those of conventional methods; and

FIG. 7A, FIG. 7B, FIG. 7C, FIG. 7D, FIG. 7E, and FIG. 7F show performance comparison results of the method according to an exemplary embodiment of the present disclosure in comparison with conventional methods.

### DETAILED DESCRIPTION

For a clearer understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

In the description of exemplary embodiments of the present disclosure, “at least one of A and B” may mean “at least one of A or B” or “at least one of combinations of one or more of A and B”. In addition, in the description of exemplary embodiments of the present disclosure, “one or more of A and B” may mean “one or more of A or B” or “one or more of combinations of one or more of A and B”.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanying drawings. In order to facilitate general understanding in describing the present disclosure, the same components in the drawings are denoted with the same reference signs, and repeated description thereof will be omitted.

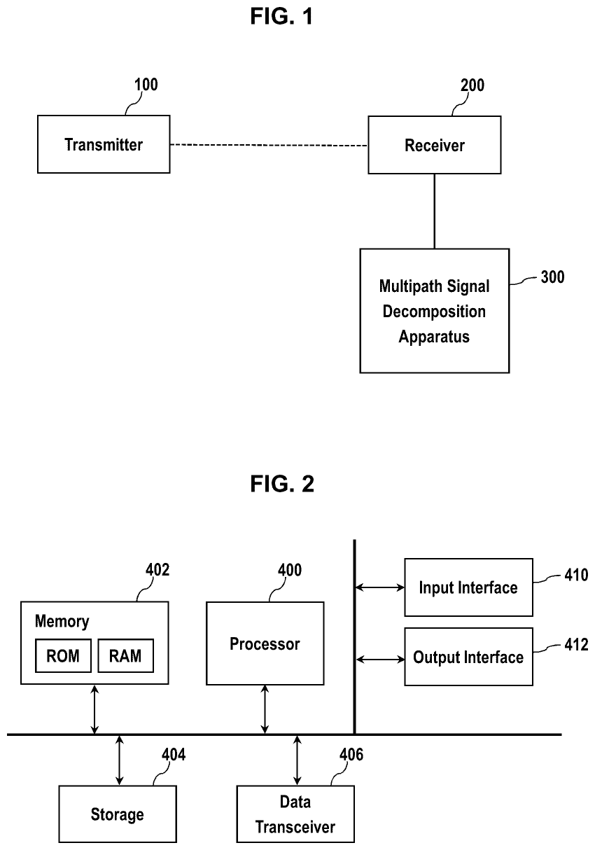

FIG. 1 is a block diagram of a communication system according to an exemplary embodiment of the present disclosure. The communication system may include a transmitter 100 transmitting a signal and a receiver 200 receiving the signal. The communication system may further include a multipath signal decomposition apparatus 300 decomposing multipath signal components from the signal received by the receiver 200.

The transmitter 100 may transmit the signal encoded and modulated according to a certain wireless communications protocol. The receiver 100 may demodulate and decode the signal received from the transmitter 100 to reconstruct original data or original signal. The signal received by the receiver 100 may be a superposition of various signal components having propagated in various paths and arriving with various time delays, angles of departure, angles of arrival, Doppler frequencies, polarizations, and reception powers. The multipath signal decomposition apparatus 300 may receive and store the signal received by the receiver 100 and may decompose a real-time signal or a stored signal into a plurality of multipath signal components.

In an exemplary embodiment, the transmitter 100 may be a base station and the receiver 100 may be a terminal. However, the transmitter 100 may be the terminal and the receiver 100 may be the base station. Meanwhile, the multipath signal decomposition apparatus 300 may be provided separately from the receiver 100. Alternatively, however, the multipath signal decomposition apparatus 300 may be implemented in a single device integrated with the receiver 100. For example, the multipath signal decomposition apparatus 300 may be implemented within the receiver 100.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Throughout the present disclosure, the terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

The terminal may be an arbitrary data processing device having communication capability such as a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like.

The base station and the terminal may support at least one of communication protocols defined in the 3rd generation partnership project (3GPP) technical specifications such as LTE communication protocol, LTE-A communication protocol, NR communication protocol, or the like. However, the communication systems to which the exemplary embodiments according to the present invention are applicable are not limited thereto, and the present invention may be applied to various communication systems. Here, the communication system may be used in the same sense as a communication network. The term ‘LTE’ may refer to ‘4G communication system’, ‘LTE communication system’, or ‘LTE-A communication system’, and ‘NR’ may refer to ‘5G communication system’ or ‘NR communication system’.

For the 4G communication and the 5G communication, the base station and the terminal may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like, for example.

The communication system shown in FIG. 1 may further include a core network (not shown). In case that the communication system 100 is a 4G communication system (e.g., the LTE system), the core network may include a serving gateway (S-GW), a packet data network (PDN) gateway (P-GW), and a mobility management entity (MME). In case that the communication system 100 is a 5G communication system (e.g., the NR system), the core network may include an access and mobility management function (AMF), a user plane function (UPF), a session management function (SMF), and the like.

FIG. 2 is a block diagram showing a physical configuration of the multipath signal decomposition apparatus 300 according to an exemplary embodiment. The multipath signal decomposition apparatus 300 may include a processor 400, a memory 402, a storage 404, and a data transceiver 406. The multipath signal decomposition apparatus 300 may further include an input interface 410 and an output interface 412. At least some of the components of the multipath signal decomposition apparatus 300 including the processor 400 and the memory 402 may be connected to each other by a bus.

The processor 400 may execute program instructions stored in the memory 402 and/or the storage 404. The processor 400 may include a central processing unit (CPU) or a general processing unit (GPU), or may be implemented by another kind of dedicated processor suitable for performing the method of the present disclosure. The processor 400 may execute program instructions for implementing the multipath signal decomposition method according to the present disclosure.

The memory 402 may include, for example, a volatile memory such as a read only memory (ROM) and a nonvolatile memory such as a random access memory (RAM). The memory 402 may load the program instructions stored in the storage 404 to provide to the processor 400 so that the processor 400 may execute the program instructions.

The storage 404 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD). The storage 404 may store the program instructions for implementing the multipath signal decomposition method according to the present disclosure.

Before describing the multipath signal decomposition method performed by the multipath signal decomposition apparatus 300, a theoretical basis of a projection maximization (ProMax) algorithm forming the basis of the multipath signal decomposition method according to the present disclosure is explained.

Assuming a time-invariant channel with two paths, a received signal may be expressed by Equation 1.

$$\tilde{r} ( τ ) = {c}_{0} \cdot r ( τ - {τ}_{0} ) + {c}_{1} \cdot r ( τ - {τ}_{2} ) \qquad [ Equation 1 ]$$

Here, ‘r’ and ‘\tilde{r} ’ denote a reference signal transmitted by the transmitter and a received signal received by the receiver, respectively. ‘cₙ’ and ‘τₙ’ denote a complex amplitude and a delay of an n-th multipath signal component, respectively. In case that the reference signal is a Dirac impulse, the multipath signals are orthogonal to each other for different delays. However, due to a limited sampling, the observed multipath signals are correlated with each other. For a signal with a finite bandwidth of a rectangular spectral shape, the multipath signals have waveforms of sinc functions determined by a convolution with the Dirac impulse. In general, when a spacing between multipath components (MPCs) are small, it is likely that there is a high correlation between the multipath signals. Further, the correlation increases as the bandwidth decreases. As a result, the received signal may be represented as a superposition of correlated multipath signals. The correlation between the multipath signals is caused by limitations in the bandwidth, a measurement time, and an antenna size.

A sampling kernel may be expressed as a function of parameters such as a signal label, time, space, and a Doppler frequency depending on a propagation environment and a sampling method. A sampled signal having N signal components may be expressed by Equation 2.

$$\overline{y} = {\sum }_{n = 0}^{N - 1} \overline{b} ( {\overline{θ}}_{n} ) \cdot {c}_{n} + \overline{w} \qquad [ Equation 2 ]$$

Here, ‘y̅’, ‘b̅(·)’, and ‘w̅’ denote measured data, the sampling kernel, and an observation error caused by a noise, respectively. ‘θ̅ₙ’ denotes an input parameter vector of the sampling kernel for the n-th multipath signal component (hereinafter, referred to as ‘n-th signal component’). ‘b̅(θ̅ₙ)’ denotes the n-th signal component and may also be referred to as the n-th basis vector. For example, assuming a stationary uncorrelated scattering in a broad sense, the sampling kernel in the channel estimation of a cellular system using a time-varying MIMO channel model may be expressed by Equation 3.

$$\overline{b} ( {\overline{θ}}_{n} ) = \overline{R} ( \overline{f} , \overline{t} , \overline{{p}_{n}} ) \cdot ( {e}^{- j 2 π \overline{f} {τ}_{n}} ⊗ {e}^{j 2 π {v}_{n} \overline{t}} ) ⊗ {\overline{F}}_{TX} ( {θ}_{n}^{AoD} ) ⊗ {\overline{F}}_{RX} ( {θ}_{n}^{AoA} ) \qquad [ Equation 3 ]$$

$$where {\overline{θ}}_{n} = \{ {θ}_{n}^{AoD} {θ}_{n}^{AoA} {τ}_{n} {v}_{n} \}$$

Here, ‘pₙ’ and ‘R̅(·)’ denote a physical cell identifier (PCI) or a base station index, and an n-th reference signal determined by the PCI, respectively. ‘F̅_{TX}(·)’ and ‘F̅_{RX}(·)’ denote steering vectors determined by the angle of departure (AoD) and angle of arrival (AoA) of a corresponding multipath component, and ⊗ denotes a Kronecker product. ‘θₙ^{AoD}’, ‘θₙ^{AoA}’, ‘τₙ’, and ‘vₙ’ denote the angle of departure, the angle of arrival, the delay, and the Doppler frequency of the n-th multipath, respectively. ‘t̅’ and ‘f̅’ are vectors of measurement time and frequency.

Equations 2 and 3 may be expressed in matrix forms of Expression 4.

$$\overline{y} = B ( {Θ}_{N} ) \cdot \overline{c} + \overline{w} \qquad [ Equation 4 ]$$

$$where B ( {Θ}_{N} ) = [ \overline{b} ( {\overline{θ}}_{0} ) \overline{b} ( {\overline{θ}}_{1} ) … \overline{b} ( {\overline{θ}}_{N - 1} ) ]$$

$$\overline{c} = {[ {c}_{0} {c}_{1} … {c}_{N - 1} ]}^{T}$$

$${Θ}_{N} = \{ {\overline{θ}}_{0} {\overline{θ}}_{1} … {\overline{θ}}_{N - 1} \}$$

The multipath signal decomposition method according to the exemplary embodiment acquires the multipath signal components, i.e., a parameter matrix Θ_{N} and a magnitude matrix c̅ of the multipath signal components, from the observation data ‘y̅’. In particular, a projection maximization (ProMax) algorithm which forms a basis of the multipath signal decomposition method according to an exemplary embodiment aims attempts to find a set of multipath components (MPCs) with a minimum number of MPCs while avoiding a redundancy of the basis vectors. An algorithm according to an exemplary embodiment has a double loop structure for probabilistic search. If a newly discovered MPC is correlated with at least one of previously discovered MPCs, all MPCs are updated with new optimal values. The algorithm according to an exemplary embodiment gradually increases an index N in an outer loop and performs a probabilistic optimization in an inner loop. In an exemplary embodiment, essential basis vectors for a sparsest representation are searched in such a manner.

The sparsest representation problem may be expressed by Equation 5.

$${minimize}_{{Θ}_{N} , \overline{c}} {‖ \overline{c} ‖}_{0} \qquad [ Equation 5 ]$$

$$subject to {‖ \overline{y} - B ( {Θ}_{N} ) \cdot \overline{c} ‖}_{2}^{2} < tolerence$$

The sparsest representation problem is a non-deterministic polynomial-time hard problem of a very high complexity and is regarded as a combinatorial optimization problem. As the number of the parameters increases, the number of parameter combinations increases exponentially, and thus it is inefficient to search for all combinations. Hence, greedy algorithms or stochastic optimization algorithms are widely used. The greedy algorithms sacrifice the accuracy for the fast implementation. The stochastic optimization aim for accurate parameter estimation, but it is difficult to implement a real-time operation. The method of the present disclosure may be regarded as a kind of stochastic optimization method for finding the sparsest representation.

According to an exemplary embodiment, the optimization problem is reconfigured from the Equation 5 to Equation 6 as follows in order to find the sparsest representation.

$${mimimize}_{{Θ}_{N} , \overline{c}} {‖ \overline{y} - B ( {Θ}_{N} ) \cdot \overline{c} ‖}_{2}^{2} \qquad [ Equation 6 ]$$

$$subject to {‖ \overline{c} ‖}_{0} = N$$

According to an exemplary embodiment, in the reconfigured optimization problem, the algorithm finds a minimum value of N by repeatedly incrementing the value N until a certain termination condition is satisfied. An example of the termination condition is that an objective function, e.g., a residual, falls below a preset tolerance level. Another example of the termination condition is that the value of N reaches a pre-defined maximum value. Another example of the termination condition is that an amount of computations reaches a preset upper limit for a total amount of computations. Besides, the termination conditions may be implemented in various ways.

Meanwhile, one of the other features of the algorithm according to an exemplary embodiment is a sub-optimization in each iteration. The sub-optimization is based on an assumption of optimal coefficients and a consideration of MPCs found in previous searches when searching for a new basis vector. Given the basis vectors, a complex amplitude of the basis vectors minimizing the residual may be calculated using a least squares method as in Equation 7.

$$\overline{c} ( {Θ}_{N} ) = {( {B}^{H} ( {Θ}_{N} ) \cdot B ( {Θ}_{N} ) )}^{- 1} \cdot {B}^{H} ( {Θ}_{N} ) \cdot \overline{y} \qquad [ Equation 7 ]$$

If the Equation 7 is substituted into the Equation 6, an objective function may be expressed as Equation 8.

$${‖ \overline{y} - Z \cdot \overline{y} ‖}_{2}^{2} = {\overline{y}}^{H} \cdot \overline{y} - {\overline{y}}^{H} \cdot ( Z + {Z}^{H} - {Z}^{H} \cdot Z ) \cdot \overline{y} \qquad [ Equation 8 ]$$

Here, Z may be expressed by Equation 9.

$$Z = {( {B}^{H} ( {Θ}_{N} ) \cdot B ( {Θ}_{N} ) )}^{- 1} \cdot {B}^{H} ( {Θ}_{N} ) \qquad [ Equation 9 ]$$

According to a definition of Z(Θ_{N}), Equation 10 holds.

$$Z = {Z}^{H} = {Z}^{H} \cdot Z \qquad [ Equation 10 ]$$

Using the Cholesky decomposition, a positive-definite Hermitian matrix may be decomposed into a product of a lower triangular matrix and its conjugate transpose as in Equation 11.

$${B}^{H} ( {Θ}_{N} ) \cdot B ( {Θ}_{N} ) = L ( {Θ}_{N} ) \cdot {L}^{H} ( {Θ}_{N} ) \qquad [ Equation 11 ]$$

Here, L is a lower triangular matrix. Using Equations 10 and 11, Equation 8 may be simplified into Equation 12.

$$\begin{matrix}{‖ \overline{y} - Z \cdot \overline{y} ‖}_{2}^{2} = {\overline{y}}^{H} \cdot \overline{y} - {\overline{y}}^{H} \cdot Z \cdot \overline{y} \\ = {\overline{y}}^{H} \cdot \overline{y} - {P ( \overline{y} , {Θ}_{N} )}^{H} \cdot P ( \overline{y} , {Θ}_{N} )\end{matrix} \qquad [ Equation 12 ]$$

Here, P(y̅, Θ_{N}) may be expressed by Equation 13.

$$P ( \overline{y} , {Θ}_{N} ) = {L}^{- 1} ( {Θ}_{N} ) \cdot {B}^{H} ( {Θ}_{N} ) \cdot \overline{y} \qquad [ Equation 13 ]$$

Equation 12 shows that the residual is equal to the observation data y̅^{H}·y̅ minus the projection of the observation data onto the basis vector y̅^{H}·Z(Θ)·y̅. Thus, the minimization of the residual is the same problem as the maximization of the projection. Therefore, a new objective function may be expressed by Equation 14.

$${maximize}_{{Θ}_{N}} {P ( \overline{y} , {Θ}_{N} )}^{H} \cdot P ( \overline{y} , {Θ}_{N} ) \qquad [ Equation 14 ]$$

$$subject to \overline{c} = {( {B}^{H} ( {Θ}_{N} ) \cdot B ( {Θ}_{N} ) )}^{- 1} \cdot {B}^{H} ( {Θ}_{N} ) \cdot \overline{y}$$

In the SAGE algorithm, the magnitude of the basis vector c̅ is used as an input value of the objective function to minimize the magnitude of the residual ∥y̅−Z·y̅∥₂² in the objective function of a stochastic search process. Contrarily, in the method according to an exemplary embodiment of the present disclosure, the magnitude of the basis vector c̅ is not used as an input value of the objective function ∥y̅−Z·y̅∥₂² for maximizing the projection in the stochastic search process. A convergence and an accuracy of the SAGE algorithm may be significantly low since the SAGE algorithm performs the stochastic optimization using inaccurate basis vector magnitude information. However, the algorithm according to an exemplary embodiment of the present disclosure may exhibit the convergence and the accuracy superior to those of the SAGE algorithm because optimal values of basis vector magnitudes are always assumed in the stochastic optimization process instead of using an estimation result for the basis vector magnitudes.

According to an exemplary embodiment, the amount of computations required for the stochastic search to maximize a projection increases significantly as the number of the basis vectors increases. Therefore, when the number of basis vectors is large, the computational efficiency may decrease in the process of maximizing the projection. Taking this problem into account, the basis vectors used in the maximization of the projection may be limited to a subset of the entire set of the basis vectors to improve a computational efficiency. A performance of estimating the magnitudes of the basis vectors varies according to an orthogonality between the basis vectors. Therefore, if the subset of the basis vectors to be optimized is constructed to exclude the basis vectors that are highly orthogonal to a most recently added basis vector in the stochastic optimization process, the amount of computations may be reduced significantly with little degradation in performance compared with a case of performing the algorithm using the entire set of the basis vectors. In case that the most recently added basis vector has a low correlation with other basis vectors, the subset selected in the stochastic optimization process may be an empty set. In case that all the basis vectors have a high correlation with each other, the subset may be the entire set. Meanwhile, it is desirable to perform the residual calculation after removing the basis vector components that do not belong to the subset used in the stochastic optimization process from the measured signal.

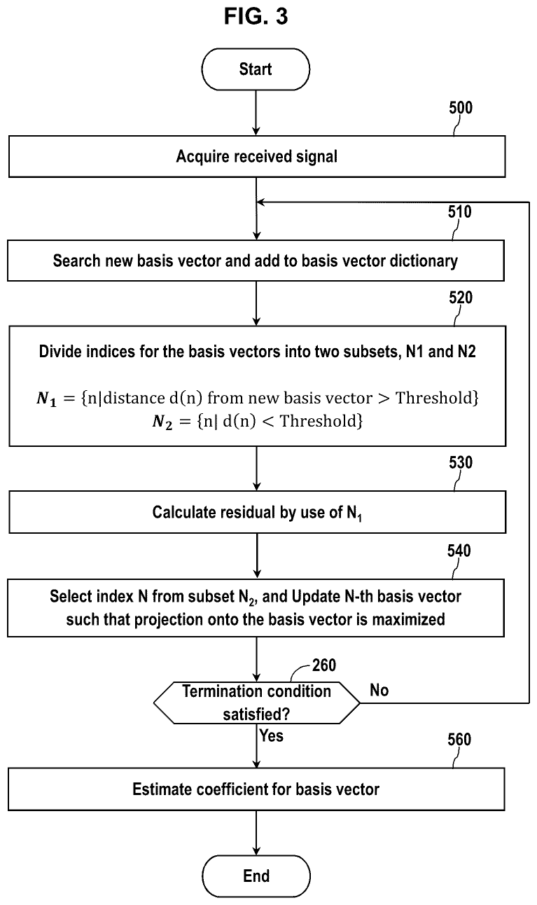

FIG. 3 is a flowchart showing a multipath signal decomposition method according to an exemplary embodiment of the present disclosure.

First, the observation data including the multipath signal components is acquired from a signal received by the receiver 100 (operation 500). The signal from which the observation data is extracted may be a reference signal received by the receiver 100, but the present disclosure is not limited thereto. Meanwhile, the observation data may also be the received reference signal itself.

Next, a new basis vector is searched and added to a basis vector dictionary (operation 510).

In operation 520, indices for the basis vectors included in the basis vector dictionary are divided into two subsets, N1 and N2. Here, N1 is a set of indices for the basis vectors whose distance d(n) from the basis vector added in the operation 510 is greater than a threshold value determined in advance. N2 is a set of the indices for basis vectors whose distance d(n) from the newly added basis vector is smaller than the threshold value.

Afterwards, the residual may be calculated by use of N1 (operation 530). Then, an index Nis selected from the subset N2, and an N-th basis vector is updated such that a projection onto the basis vector is maximized (operation 540). Here, the projection refers to a projection of the observation data onto the basis vector in a first iteration, and may mean a projection of the residual onto the basis vector in subsequent iterations. Sub-optimization of operations 510-540 is repeatedly carried out so that an addition and update of a basis vector may be repeatedly performed until the termination condition, i.e., a convergence condition, is satisfied in operation 550.

If it is determined in operation 550 that the termination condition is satisfied, coefficients for the basis vectors are estimated (operation 560). An example of a termination condition may be that the objective function value falls below a certain tolerance level. Another example of the termination condition is that the index N reaches a pre-defined maximum value. Another example of the termination condition is that the amount of computations reaches a preset upper limit for the total amount of computations.

As described above, the multipath signal decomposition method according to an exemplary embodiment may obtain the sparsest solution by finding a solution to the objective function while starting the index N from 1 and increasing by 1 until the residual falls below an acceptable level. As mentioned above, the algorithm according to an exemplary embodiment has a double loop structure for a stochastic search. If a newly discovered MPC is correlated with previously discovered MPCs, all MPCs are updated to new optimal values. The algorithm according to an exemplary embodiment gradually increases the index N in the outer loop and performs the stochastic optimization in the inner loop.

Accordingly, a new basis vector is searched assuming that the current index N is the maximum value of N, and the sub-optimization process is performed. After confirming that it is possible to derive the optimal coefficients for the current index N, the index N is incremented and the process is repeated. The multipath signal decomposition method according to an exemplary embodiment is computationally intensive because the computations include matrix inverse operations during the sub-optimization process. Fortunately, the matrix inverse operations includes a definite Hermitian matrix B^{H}(Θ_{N})·B(ΘN), which may be efficiently implemented using the Cholesky decomposition. The effect of the sub-optimization on the computations significantly increases as the index N increases. When the index N is small, the effect of the sub-optimization on the computations is at a minimum. Because of this property, the multipath signal decomposition method according to an exemplary embodiment is suitable for achieving the sparsest representation with a minimum number of N.

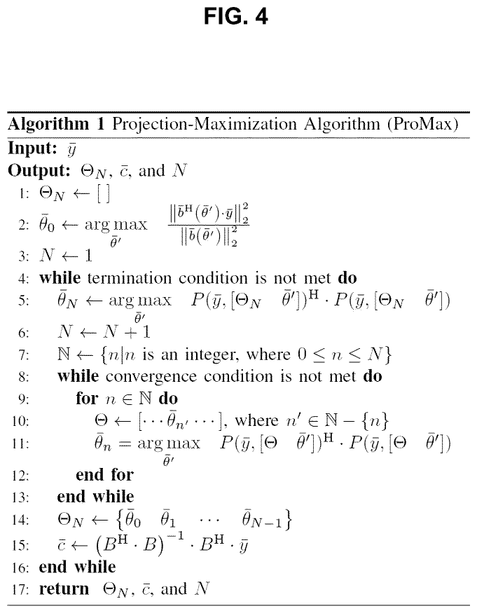

FIG. 4 shows a pseudocode of the projection maximization (ProMax) algorithm according to an exemplary embodiment of the present disclosure. As can be seen in the pseudocode, the estimation of a coefficient matrix c̅(Θ_{N}) is performed only once at the end. Therefore, the performance of the sub-optimization in the iterative loop is not degraded due to any coefficient estimation errors in a previous operation. This property is valuable even though each sub-optimization step involves only a non-negligible amount of computations because it significantly accelerates the convergence of the algorithm.

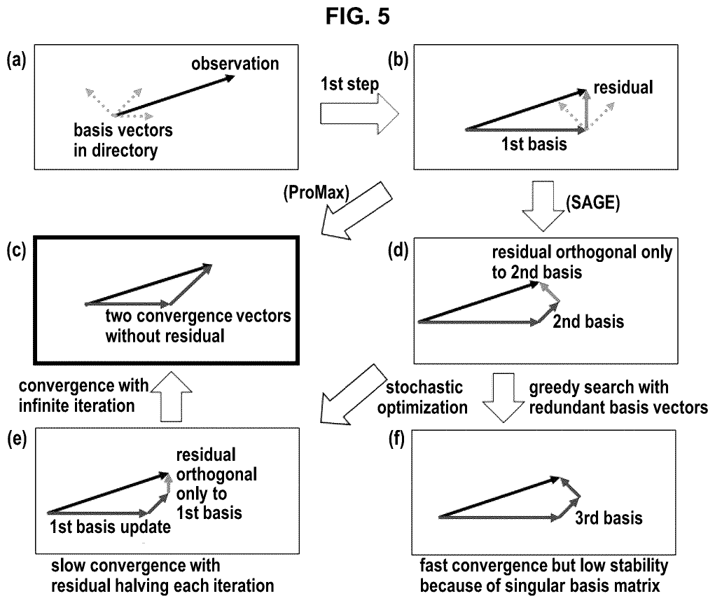

FIG. 5 shows a parameter estimation process performed by the multipath signal decomposition method according to an exemplary embodiment in comparison with a process performed by the conventional SAGE algorithm. It is assumed that the observation data is (3,1) and the basis vectors that may come out from the parameter estimation process are limited to three vectors:

$$( 1 , 0 ) , ( \frac{1}{\sqrt{2}} , \frac{1}{\sqrt{2}} ) , ( - \frac{1}{\sqrt{2}} , \frac{1}{\sqrt{2}} ) ,$$

In the parameter estimation process according to an exemplary embodiment, the vector (1, 0) closest to the observation data is first selected as a first basis vector. Then, if the vector

$$( \frac{1}{\sqrt{2}} , \frac{1}{\sqrt{2}} )$$

is found as a second basis vector, a calculation result for the residual (y̅^{H}·y̅−y̅^{H}·Z·y̅) becomes a zero matrix and the algorithm is terminated immediately. That is, the process may be accomplished in a sequence starting from a state (a) and through the operations (b) and (c).

In contrast, in case of the SAGE, the algorithm is not terminated due to a basis vector magnitude estimation error. Here, if there is no limitation on the number of the basis vectors, unnecessary basis vectors are additionally found and the range of parameter estimation errors increases due to the basis vectors with low orthogonality. For example, after finding a second basis vector, the algorithm may calculate a residual that is orthogonal only to a second basis vector (operation (d)). Then, the algorithm may perform a greedy search with redundant basis vector (operation (f)). Thus, the process may be accomplished in a sequence starting from the state (a) and through the operations (b), (d), and (f). In this case, the parameter estimation results may be sensitive to noise and unstable. That is, the algorithm provides a fast convergence, but the stability is low because of singular basis matrices.

If the number of the basis vectors is appropriately limited, after calculating the residual that is orthogonal only to the second basis vector in the operation (d), the algorithm may calculate a residual that is orthogonal only to a first basis vector, for example (operation (e)). Then, the algorithm may perform lots of iterations to derive a final parameter estimation result (operation (c)). Thus, the process may be accomplished in a sequence starting from the state (a) and through the operations (b), (d), (e) and (c). As a result, even in the case where the number of the basis vectors is appropriately limited, the algorithm converges slowly because of the basis vector magnitude estimation error, which requires a large amount of computations.

Simulations were performed to compare the performance of the method according to an exemplary embodiment of the present disclosure with conventional methods. In the simulations, two ray channels with different delay spacings were generated and the channel parameter estimation algorithms were applied. Performance indicators used in the simulations include an absolute error (AE) of a delay difference estimation, a mean squared error (MSE) of a reconstructed signal, and an empirical cumulative distribution function (eCDF) of the amount of the computations (i.e., a runtime and a number of iterations) until the convergence.

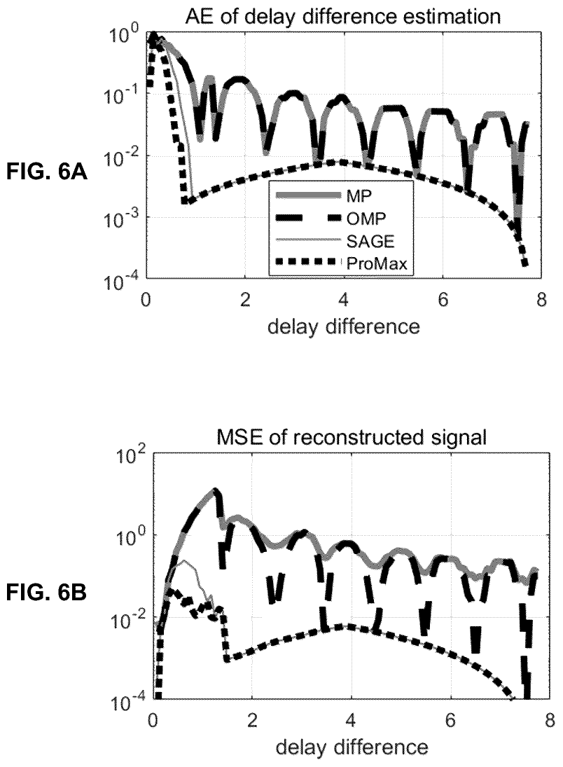

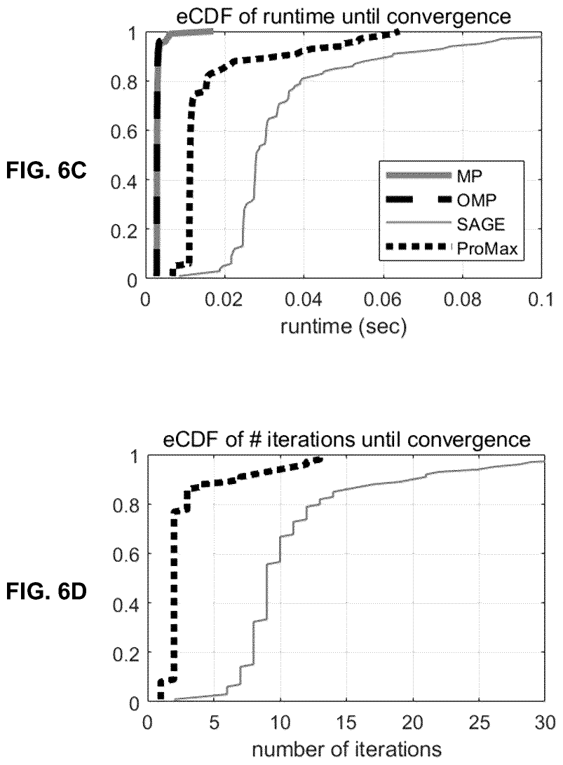

FIGS. 6A through 6D show simulation results of the method according to an exemplary embodiment of the present disclosure in comparison with those of conventional methods. The conventional methods include the Matching Pursuit (MP) algorithm which may be the most basic method, the Orthogonal Matching Pursuit (OMP) algorithm which is one of the derivatives of the MP algorithm, and the SAGE algorithm. The MP-based techniques requires a very small amount of computations because it involves no iteration, but revealed a low parameter estimation performance. The method according to an exemplary embodiment exhibited a highest parameter estimation performance while requiring only a smaller amount of computations than the SAGE algorithm.

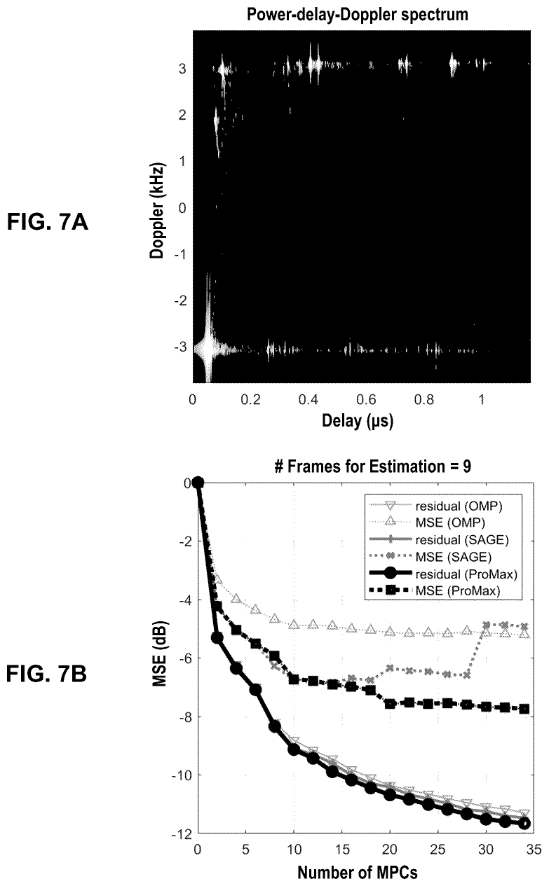

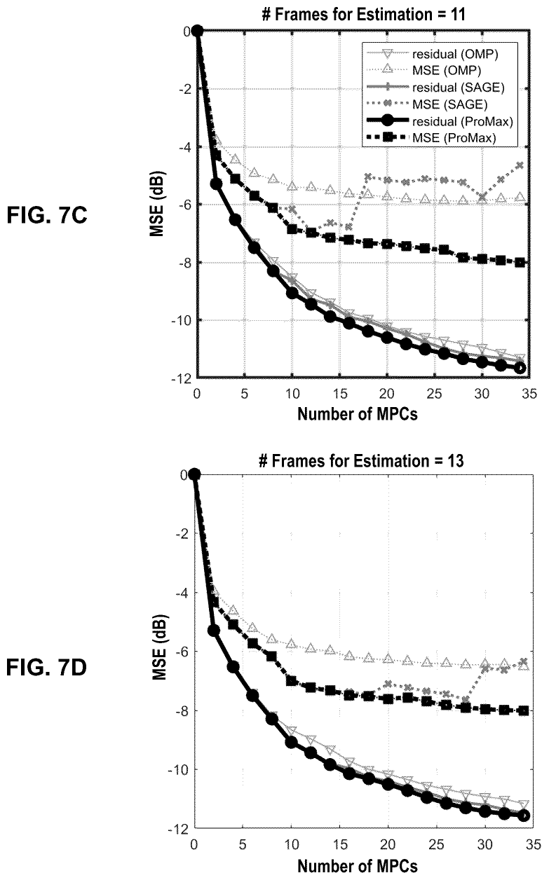

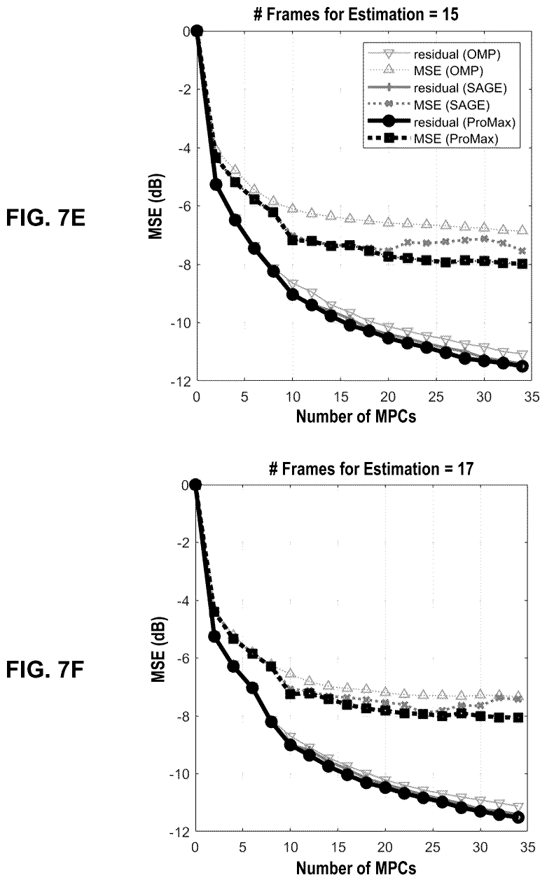

FIGS. 7A through 7F shows performance comparison results of the method according to an exemplary embodiment of the present disclosure in comparison with conventional methods.

FIG. 7A shows a 28-GHz channel measured in a train running at 116 km/h in a tunnel, and the SNR was about 14 decibels (dB). A sequence with a maximum length of 4095 was used, and a measurement bandwidth was 500 Megahertz (MHz). A number of frames was 305, and a frame interval was 32.768 microseconds (μs). Out of the 4095×305 samples, 585×M samples consisting of {4, 11, 18, . . . , 4092}-th frequency samples of the (153+4i)-th frames were used for the MPC estimation. Here, idenotes integers from (−M−1)/2 to (M−1)/2.

FIGS. 7B to 7F show the MPC estimation results. The solid lines and the dotted lines represent the residuals to the observation and the mean squared error (MSE) between the full measurement and reconstructed signal using the estimated MPCs, respectively, both of which were normalized by a received signal power. While the residuals of all the algorithms decrease with the increase in the number of MPCs, the MSE may increase due to overfitting. Initially, both the SAGE and the ProMax exhibited faster decreases in the residual and MSE compared to the OMP as the number of MPCs increases. However, while the SAGE exhibited unstable MSE due to overfitting, the ProMax consistently demonstrated stable performance. For the algorithm implementations, an exhaustive search was performed to maximize the projection onto the residual using the measurement resolutions only when initializing the MPCs, and then each sub-optimization was conducted with a coordinate descent and line search algorithms, where the step size update factor was set to 0.5. The maximum number of iterations was set to 300 and 20 for the SAGE and the ProMax, respectively. The values are approximately at a point where the RMSE became 0.07/B.

The apparatus and method according to exemplary embodiments of the present disclosure can be implemented by computer-readable program codes or instructions stored on a computer-readable intangible recording medium. The computer-readable recording medium includes all types of recording device storing data which can be read by a computer system. The computer-readable recording medium may be distributed over computer systems connected through a network so that the computer-readable program or codes may be stored and executed in a distributed manner.

The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the device or apparatus may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by use of a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure may be merely exemplary in nature and, thus, variations that do not depart from the substance of the disclosure may be intended to be within the scope of the disclosure. Such variations may not be to be regarded as a departure from the spirit and scope of the disclosure. Thus, it will be understood by those of ordinary skill in the art that various changes in form and details may be made without departing from the spirit and scope as defined by the following claims.

What is claimed is:

1. A multipath signal decomposition method, comprising:
(a) acquiring observation data including a plurality of multipath signal components from a signal received by a communication receiver;
(b) for each multipath signal component, determining one or more basis vectors maximizing a projection to add to a basis vector dictionary;
(c) calculating a residual using basis vectors having an orthogonality higher than a predetermined reference level with a new basis vector newly added to the basis vector dictionary and performing a sub-optimization of the basis vector dictionary by updating a basis vector maximizing a projection of the residual among the basis vectors having the orthogonality lower than the reference level;
(d) when a predetermined termination condition is not satisfied, repeatedly performing the operations (b) and (c) to determine an additional basis vector and determine basis vectors of a minimum number which may express a corresponding multipath signal component while avoiding a redundancy of the basis vectors; and
(e) when the termination condition is satisfied, determining coefficients of basis vectors of the minimum number and path parameters for the corresponding multipath signal component.

2. The multipath signal decomposition method of claim 1, wherein, in the operation (a), the observation data is acquired from a reference signal received by the communication receiver.

3. The multipath signal decomposition method of claim 1, wherein, in the operation (b), the projection is a projection of the observation data in a first iteration and is a projection of the residual in a second and subsequent iterations.

4. The multipath signal decomposition method of claim 1, wherein the operation (c) comprises:
determining a first subset to which the basis vectors having a distance greater than a predetermined threshold belong among basis vectors included in the basis vector dictionary and a second subset to which the basis vectors having the distance smaller than the threshold belong;
calculating a residual using the observation data and the basis vectors belonging to the first subset; and
determining a basis vector onto which the projection of the residual is maximized among the basis vectors belonging to the second subset.

5. The multipath signal decomposition method of claim 4, further comprising:
updating all basis vectors when the new basis vector is correlated with existing basis vectors.

6. The multipath signal decomposition method of claim 1, wherein the termination condition is that an objective function falls below a predetermined tolerance level.

7. The multipath signal decomposition method of claim 1, wherein the termination condition is that a number of the basis vectors reaches a predetermined maximum value.

8. The multipath signal decomposition method of claim 1, wherein the termination condition is that an amount of computations reaches a predetermined upper limit for a total amount of computations.

9. A multipath signal decomposition apparatus, comprising:
a processor; and
a memory storing program instructions to be executed by the processor,
wherein the program instructions when executed by the processor causes the processor to:
(a) acquire observation data including a plurality of multipath signal components from a signal received by a communication receiver;
(b) for each multipath signal component, determine one or more basis vectors onto which a projection is maximized to add to a basis vector dictionary;
(c) calculate a residual using basis vectors having an orthogonality higher than a predetermined reference level with a new basis vector newly added to the basis vector dictionary and perform a sub-optimization of the basis vector dictionary by updating a basis vector maximizing a projection of the residual among the basis vectors having the orthogonality lower than the reference level;
(d) when a predetermined termination condition is not satisfied, repeatedly perform the operations (b) and (c) to determine an additional basis vector and determine basis vectors of a minimum number which may express a corresponding multipath signal component while avoiding a redundancy of the basis vectors; and
(e) when the termination condition is satisfied, determine coefficients of basis vectors of the minimum number and path parameters for the corresponding multipath signal component.

10. The multipath signal decomposition apparatus of claim 9, wherein, in performing the operation (a), the observation data is acquired from a reference signal received by the communication receiver.

11. The multipath signal decomposition apparatus of claim 9, wherein, in performing the operation (b), the projection is a projection of the observation data in a first iteration and is a projection of the residual in a second and subsequent iterations.

12. The multipath signal decomposition apparatus of claim 9, wherein the program instructions causing the processor to perform the operation (c) comprises instructions causing the processor to:
calculate the residual using the basis vectors having the distance from the new basis vector greater than the threshold and update the basis vectors having the distance smaller than the threshold such that the projection of the residual is maximized;
determine a first subset to which the basis vectors having the distance greater than the threshold among basis vectors included in the basis vector dictionary belong and a second subset to which the basis vectors having the distance smaller than the threshold belong;
calculate a residual between the observation data and a combination of the basis vectors belonging to the first subset; and
determine a basis vector onto which the projection of the residual is maximized among the basis vectors belonging to the second subset.

13. The multipath signal decomposition apparatus of claim 12, wherein the program instructions causes the processor to:
update all basis vectors when the new basis vector is correlated with existing basis vectors.

14. The multipath signal decomposition apparatus of claim 9, wherein the termination condition is that an objective function falls below a predetermined tolerance level.

15. The multipath signal decomposition apparatus of claim 9, wherein the termination condition is that a number of the basis vectors reaches a predetermined maximum value.

16. The multipath signal decomposition apparatus of claim 9, wherein the termination condition is that an amount of computations reaches a predetermined upper limit for a total amount of computations.
